(19) United States
(12) Patent Application Publication
(10) Pub. No.: US 2025/0059743 A1
(43) Pub. Date: Feb. 20, 2025

(54) ELECTRONIC FAUCET INCLUDING A SCHEDULER

(71) Applicant: Delta Faucet Company, Indianapolis, IN (US)

(72) Inventors: Joel D. Sawaski, Indianapolis, IN (US); Michael Scot Rosko, Greenwood, IN (US)

(21) Appl. No.: 18/719,014

(22) PCT Filed: Dec. 19, 2022
(86) PCT No.: PCT/US2022/053362

§ 371 Date: Jun. 12, 2024

Related U.S. Application Data
(60) Provisional application No. 63/290,990, filed on Dec. 17, 2021.

(51) Int. Cl. E03C 1/05; E03B 7/12; F16K 37/00

(52) U.S. Cl. CPC E03C 1/05; E03B 7/12; F16K 37/00

(57) ABSTRACT

The present disclosure relates to an electronic faucet having a spout, a fluid passageway supported by the spout, a valve assembly including an electrically operable valve positioned to control fluid flow through the fluid passageway, a valve controller operative to control the electrically operable valve, a scheduler in communication with the valve controller, the scheduler configured to receive user input to schedule set features of the electronic faucet, and a wireless control module in communication with the valve controller and the scheduler, the wireless control module including a receiver configured to receive wireless signals from a remote transmitter and communicate with the valve controller and the scheduler to control operation of the electrically operable valve based on scheduled set features.

### CROSS-REFERENCE TO RELATED APPLICATION

The present application which claims priority to U.S. Provisional Patent Application Ser. No. 63/290,990, filed Dec. 17, 2021, the disclosure of which is expressly incorporated herein by reference.

### BACKGROUND AND SUMMARY OF THE DISCLOSURE

The present disclosure relates to an electronic faucet including an electrically operable valve. More specifically, the present disclosure relates to an electronic faucet having a controller which illustratively controls the electrically operable valve and is in communication with a wireless receiver which can be set for a variety of functions, including a scheduling function.

Electronic faucets typically include an electrically operable valve coupled to an electronic controller for controlling fluid flow though a water outlet. Some electronic faucets include controllers which can be in communication with a wireless receiver. Such communications can be used to keep a generic schedule of water dispensing.

The illustrative embodiment electronic faucet includes an electrically operable valve (e.g., a solenoid valve or an electronic proportioning valve) to control water flow from a water source to an outlet. A controller illustratively controls operation of the electrically operable valve and is in communication with a wireless receiver. Illustratively, the wireless communication may be WiFi or BLE (Bluetooth Low Energy) and can be set for a variety of functions.

A notable pain point for customers, especially living in northern extremes, is the risk of having their home plumbing pipes freeze in extreme cold situations. In order to prevent freezing pipes, users often set their faucet handles to allow some amount of water to drip into the sink, which provides sufficient flow of water through the associated home plumbing. However, this freeze protection setting of a faucet does not work with many conventional electronic faucets. Electronic faucets typically have safeguards built in such that any flow of water through their system will time out after a prescribed duration, stopping flow of water through the associated home plumbing. Additionally, some electronic faucets lack a mechanical handle to allow a dripping amount of water to be “set”.

An illustrative embodiment of the present disclosure allows a water control system (e.g., an electronic faucet) to be “set”, providing sufficient flow of water to prevent associated pipes from freezing. Additionally, the water control system of the present disclosure can be combined with wireless (e.g., WiFi or BLE) connected local weather forecasting to allow this “setting” to occur automatically, based upon the user's desired outside temperature level.

One illustrative option, via software implementation, is an algorithm which regulates the flow of water through the electronic faucet, at a given temperature, which can be user-configured via a remote user interface (e.g., a smartphone application (app)). As the controller also includes access to wireless communication (e.g., WiFi or BLE), the controller can be programmed to monitor local temperature (via communication with a weather app, for example), and control the faucet dispensing as needed, based upon a pre-determined external temperature setting.

The wireless (e.g., WiFi or BLE) enabled water control system (solenoid or motor driven) can communicate with a local weather application, and enact freeze protection dispensing of water through the homeowner's water system. Wireless communications also allow access to the water control system by the end-user, so that it can be configured to that user's desires, including water dispensing duration, frequency, etc., as well as minimal external temperature to enact dispensing.

In another illustrative embodiment of the present disclosure, the addition of a scheduling feature to an electronic faucet can provide additional benefits to the user. Features like enabling or disabling the faucet according to a schedule table (e.g. electronic calendar) may have an impact in residential and commercial faucet installations. However, such scheduling with typical electronic faucets is not feasible. The interface to enter and maintain a schedule is not present. As such, this feature is missing in conventional electronic faucets and not possible in a traditional mechanical faucet. However, once connected to wireless (e.g., WiFi or BLE), an electronic faucet can be configured to enter and maintain scheduled features.

With this wireless connectivity, the user can enter and maintain scheduled features as desired. Once selected, scheduled features can be locally or remotely managed. The wireless (e.g., WiFi or BLE) enabled water control system (e.g., solenoid or motor driven) can communicate with a time/date server to correctly execute the set faucet scheduled feature. For example, the electronic faucet may be deactivated when a user will be away from home (e.g., on vacation), or when a commercial building is unoccupied (e.g., after defined work hours).

Sabbath mode, also known as Shabbos mode (Ashkenazi pronunciation) or Shabbat mode, is a feature in many modern home appliances, including ovens and refrigerators, which is intended to allow the appliances to be used selectively (subject to various constraints) by Shabbat-observant Jews on the Shabbat and Jewish holidays. More particularly, during a Sabbath mode, electronic aspects of the appliances are disabled or inoperable.

However, the Sabbath mode does not work with conventional electronic faucets. Electronic faucets typically have safeguards built in such that any flow of water through their system will time out after a predetermined duration, stopping flow of water through the associated home plumbing. Additionally, certain features are purely electronic in nature, such as temperature monitoring. This makes a Sabbath mode difficult to implement in a traditional electronic faucet.

In an illustrative embodiment of the present disclosure, once connected to wireless (e.g., WiFi or BLE), an electronic faucet can be configured to have a holiday mode, illustratively a religious holiday mode (e.g., a Sabbath mode). More particularly, the illustrative system allows an electronic faucet to be “set” for Sabbath mode operation. An illustrative feature would be the connection to a scheduler (e.g., via the internet) for determination of the start and end times of the Sabbath.

With this connectivity, the user can determine if the holiday mode is desired. If selected, the connectivity can be used to defeature the faucet (e.g., disable or restrict electronic aspects) only during the correct times.

As detailed herein, the wireless (e.g., WiFi or BLE) enabled water control system (including an electrically operable valve) can communicate with a scheduler including a time/date server (e.g., electronic calendar) to correctly determine the faucet feature setting or mode of operation. In an illustrative holiday mode, this may be full feature during non-Sabbath and restricted feature during the Sabbath.

Using the indicator base of an electronic faucet as a night light is known. A known problem has been when to turn the night light on and off. A sensor to determine ambient light may be difficult to implement and visually unappealing on a faucet. Setting an on time and a duration is difficult on a traditional electronic faucet.

However, according to an illustrative embodiment of the present disclosure, an electronic faucet with wireless communication could be configured to accomplish a time schedule to control operation of a night light.

The wireless (e.g., Wi-Fi or BLE) enabled water control system (including an electrically operable valve) can communicate with a scheduler including a time/date server (e.g., electronic calendar) and determine when to turn the night light on and off.

A person living alone can experience problems (e.g., medical issues) that go undetected by others. An electronic faucet that keeps track of how long it has been since its last use could be utilized to detect a potential problem.

According to an illustrative embodiment of the present disclosure, a wireless (e.g., WiFi or BLE) connected faucet could be set to determine if a predetermined time has elapsed since the last use and notify a caregiver of a potential issue.

Electronic faucets that are equipped with a wireless (e.g., WiFi or BLE) connection can determine time and send notifications to predetermined individuals via stored contact information (e.g., email addresses and/or phone numbers). The wireless (e.g., WiFi or BLE) enabled water control system (including an electrically operable valve) can communicate with a scheduler including a time/date server and determine if a message should be sent.

The plumbing industry has different code requirements in different geographic locations. Current selective practice is to make special plumbing products for certain geographic areas. This can be difficult and costly. The more common practice is to make a product that conforms to the most strict code requirements. This binds everyone to the most restrictive code requirements.

In an illustrative embodiment of the present disclosure, a wireless connected electronic faucet could determine geographic area of the faucet and apply codes selectively. Illustrative examples of code requirements include maximum water flow rates, maximum water temperatures, and maximum ozone gassing, all dependent upon geographic area.

The present disclosure relates to an electronic faucet having a spout, a fluid passageway supported by the spout, a valve assembly including an electrically operable valve positioned to control fluid flow through the fluid passageway, a valve controller operative to control the electrically operable valve, and a scheduler in communication with the valve controller. The scheduler is configured to receive user input to schedule set features of the electronic faucet, thereby defining different modes of operation. A wireless control module is in communication with the valve controller and the scheduler. The wireless control module includes a receiver configured to receive wireless signals from a remote transmitter and to communicate with the valve controller and the scheduler to control operation of the electrically operable valve based on scheduled set features.

The present disclosure also provides that the illustrative scheduler is configured to provide set features including a holiday mode, a night light control mode, an aging-in-place monitoring mode, and/or a freeze prevention mode. The holiday mode allows for restricted use of the electronic faucet on religious holidays. For example, the holiday mode restricts use of the electronic faucet by Shabbat-observant users on the Sabbath and other Jewish holidays. The night light control mode provides for activation and deactivation of the night light by monitoring and reacting to date and/or time of day. The aging-in-place mode is a function wherein the scheduler is configured to monitor time lapses between uses of the faucet and report to a predetermined entity (person, number, and/or address) if a predetermined time has lapsed between uses. Finally, the freeze prevention mode includes the scheduler communicating with the wireless control module to monitor weather forecasts and to provide a freeze prevention flow rate to run according to predicted temperatures below a predetermined valve (e.g., freezing).

According to another illustrative embodiment of the present disclosure, a water control system includes a fluid passageway defining a water outlet, a valve assembly including an electrically operable valve to control fluid flow through the fluid passageway to the water outlet, and a valve controller operably coupled to the electrically operable valve. The valve controller includes a processor and a memory operably coupled to the processor, the memory configured to store date information and time information. A scheduler is in communication with the valve controller. The processor is configured to cause selective operation of the electrically operable valve between a default mode and a holiday mode in response to input from the scheduler. In the default mode, the valve controller permits operation of the electrically operable valve to provide water to the water outlet. In the holiday mode, the valve controller prevents operation of the electrically operable valve.

According to a further illustrative embodiment of the present disclosure, an electronic faucet includes a spout, a fluid passageway supported by the spout, and a valve assembly including an electrically operable valve positioned to control fluid flow through the fluid passageway. A valve controller is operative to control the electrically operable valve, the valve controller including a processor and a memory operably coupled to the processor, the memory configured to store date information and time information. A flow sensor fluidly coupled to the fluid passageway and in communication with the processor. A wireless control module is in communication with the valve controller, the wireless control module including a transceiver configured to communicate with a remote device. The processor in an aging-in-place mode of operation causes the transceiver to selectively send an alert to the remote device in response to input from the flow senor to the processor.

According to yet another illustrative embodiment of the present disclosure, an electronic faucet includes a spout, a fluid passageway supported by the spout, a valve assembly including an electrically operable valve positioned to control fluid flow through the fluid passageway, and a valve controller operative to control the electrically operable valve. A scheduler is in communication with the valve controller, the scheduler configured to receive user input to schedule set features of the electronic faucet, thereby defining different modes of operation. A wireless control module is in communication with the valve controller and the scheduler, the wireless control module including a receiver configured to receive wireless signals from a remote transmitter and communicate with the valve controller and the scheduler to control operation of the electrically operable valve based on scheduled set features. The set features include a freeze protection mode. The scheduler is configured to communicate with the wireless control module to monitor a local weather forecast.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

FIG. 1 is a block diagram illustrating an exemplary electronic faucet of the present disclosure;

FIG. 2 is a block diagram illustrating an exemplary controller and wireless control module of the electronic faucet of FIG. 1;

FIG. 3 is a perspective view of a valve assembly and a wireless control module of the illustrative electronic faucet of FIG. 1;

FIG. 4 is a perspective view of the valve assembly and the wireless control module of FIG. 3, with the valve assembly shown partially exploded;

FIG. 5 is a cross-sectional view taken along line 5-5 of FIG. 3;

FIG. 6 is a perspective view of the illustrative wireless control module of FIG. 3;

FIG. 7A is an exploded perspective view of the illustrative wireless control module of FIG. 6;

FIG. 7B is a plan view of the printed circuit board of FIG. 7A;

FIG. 8 is a cross-sectional view taken along line 8-8 of FIG. 6;

FIG. 9 is a diagrammatic representation of internet communication with the wireless control module of the present disclosure;

FIG. 10 is a diagrammatic representation of illustrative internet protocols for use with the wireless control module of the present disclosure;

FIG. 11 is a state diagram illustrating exemplary operation of the electronic faucet of FIG. 1;

FIG. 12 is a flow chart of an illustrative holiday mode of operation of the faucet of FIG. 1;

FIG. 13 is a flow chart of an illustrative freeze protection mode of operation of the faucet of FIG. 1; and

FIG. 14 is a flow chart of an illustrative aging-in-place mode of operation of the faucet of FIG. 1.

### DETAILED DESCRIPTION OF THE DRAWINGS

For the purposes of promoting and understanding the principles of the present disclosure, reference will now be made to the embodiments illustrated in the drawings, which are described herein. The embodiments disclosed herein are not intended to be exhaustive or to limit the invention to the precise form disclosed. Rather, the embodiments are chosen and described so that others skilled in the art may utilize their teachings. Therefore, no limitation of the scope of the claimed invention is thereby intended. The present invention includes any alterations and further modifications of the illustrated devices and described methods and further applications of principles in the invention which would normally occur to one skilled in the art to which the invention relates.

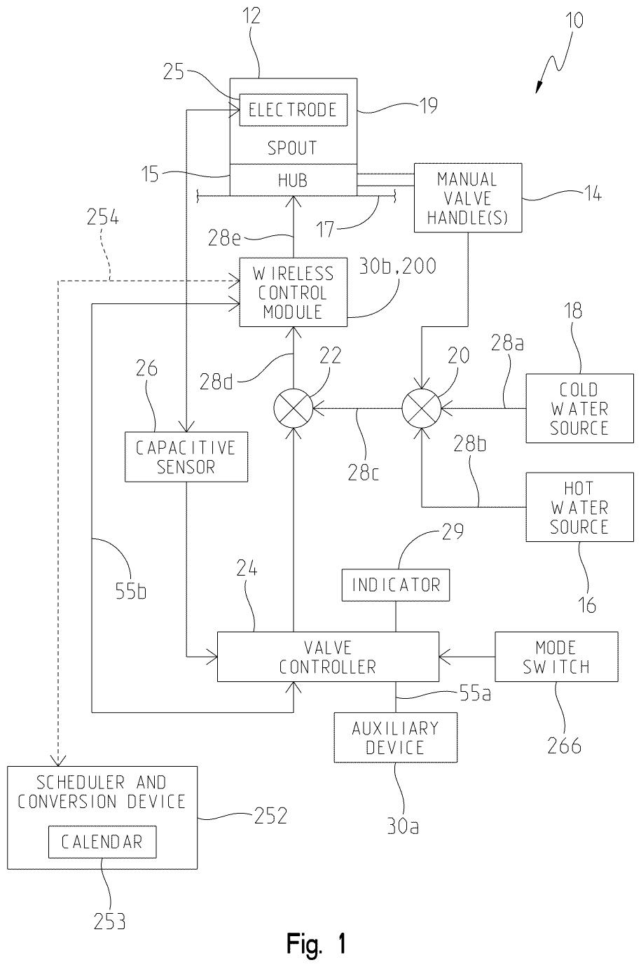

Referring initially to FIG. 1, a block diagram of a water control system, illustratively an electronic faucet 10, is shown according to some illustrative embodiments of the present disclosure. Electronic faucet 10 illustratively includes a spout 12 supported by a hub 15 and supporting a passageway or waterway (e.g., a fluid conduit) for delivering fluids such as water, for example. In the illustrative embodiment, the passageway of spout 12 includes fluid passages between hot and cold water sources 16, 18 and a water outlet 19 of spout 12. Sec, for example, passages 28a, 28b, 28c, 28d, 28c of FIG. 1.

Electronic faucet 10 illustratively includes a manual valve assembly 20 including inlets in fluid communication with hot and cold water sources 16, 18, and an outlet in fluid communication with an electrically operable valve, such as a solenoid valve 22. Solenoid valve 22 is illustratively controlled electronically by a valve controller 24. It should be noted that the controller 24 may be integral with, or separate from, the solenoid valve 22.

In the illustrative embodiment, valve controller 24 is configured to open and close solenoid valve 22 to turn on and off the fluid flow to outlet 19 of spout 12. In another illustrative embodiment, valve controller 24 is further configured to proportionally control valve 22 to adjust the flow rate and/or temperature of the fluid flowing through spout 12 to outlet 19. In an illustrative embodiment described herein, solenoid valve 22 includes a pilot operated solenoid valve, although another suitable electrically operable or actuator driven valve may be provided, such as an electronically proportional valve (EPV).

In the illustrative embodiment, valve controller 24 controls solenoid valve 22 based on output from at least one activation sensor, such as a proximity sensor and/or a touch sensor, for example, to turn on and off fluid flow through spout 12. In an illustrative embodiment, the activation sensor comprises a capacitive sensor 26 in communication with valve controller 24 for providing signals to valve controller 24 indicating the detection of an object (e.g. a user's hands) on or near spout 12 and or hub 15. Other suitable activation sensors may be provided for detecting an object near faucet 10. As illustrated, an electrode 25 of capacitive sensor 26 is coupled to spout 12 (or is part of spout 12) to detect the object contacting spout 12. Electrode 25 may be positioned in other suitable areas of faucet 10 (e.g., hub 15) for detecting the presence of a user's hands.

In the illustrative embodiment, capacitive sensor 26 and electrode 25 are used for at least one of a touch mode and a hands-free (i.e., proximity) mode of operation. In the illustrative hands free mode of operation, capacitive sensor 26 and valve controller 24 detect a user's hands or other object within a detection area or zone near spout 12. In one illustrative embodiment, the detection area includes the water stream discharged from outlet 19 and the area in the sink basin immediately surrounding the water stream. The detection area may be expanded to other areas depending on the location and sensitivity of capacitive sensor 26. In the illustrative touch mode of operation, capacitive sensor 26 and valve controller 24 detect a user's hands or other object upon contact with a surface of spout 12. To turn on the electronic faucet 10 in either mode, solenoid valve 22 is activated by valve controller 24 upon detecting the object (e.g., user's hands) to toggle water flow on and off.

In some illustrative embodiments, by sensing capacitance changes with capacitive sensor 26, valve controller 24 is configured to make logical decisions to control different modes of operation of faucet 10 such as changing between a manual mode of operation and a hands free mode of operation as described in U.S. Pat. Nos. 7,537,023; 7,690,395; 7,150,293; 7,997,301; and PCT International Patent Application Publication Nos. WO 2008/094651 and WO 2009/075858, the disclosures of which are all expressly incorporated herein by reference.

In one illustrative embodiment, manual adjustment of the water temperature and flow rate may be provided after opening the solenoid valve 22 by manipulating a manual valve handle 14. The handle 14 may be supported by the hub 15 supporting the spout 12. More particularly, hub 15 is illustratively positioned intermediate the spout 12 and a mounting deck 17 (e.g., a sink deck). In particular, manual valve handle 14 may be used to manipulate the manual valve assembly 20 positioned in the passageway of spout 12 to adjust the temperature and/or flow of fluid from the hot and cold water sources 16, 18 to solenoid valve 22. As such, the manual valve assembly 20 may be a single conventional mixing valve of the type disclosed in U.S. Pat. No. 7,753,074, the disclosure of which is expressly incorporated herein by reference. Alternatively, a separate manual valve handle 14 and associated manual valve assembly 20 may be provided for each of the hot and cold water sources 16 and 18. Alternatively, electronic faucet 10 is a fully automatic faucet without any manual controls (i.e., no manual valve assembly 20).

In an illustrative embodiment, valve controller 24 may further control valve assembly 20 electronically. In particular, valve assembly 20 may include an electronic proportioning or mixing valve that is adjusted by valve controller 24 to control the mixture of hot and cold water and thus the temperature of the water flowing through spout 12 to outlet 19. Such an electronic mixing valve 20 may be in addition to, or replace, the solenoid valve 22. Additionally, the mixing valve 20 may be replaced by separate hot and cold water proportional valves.

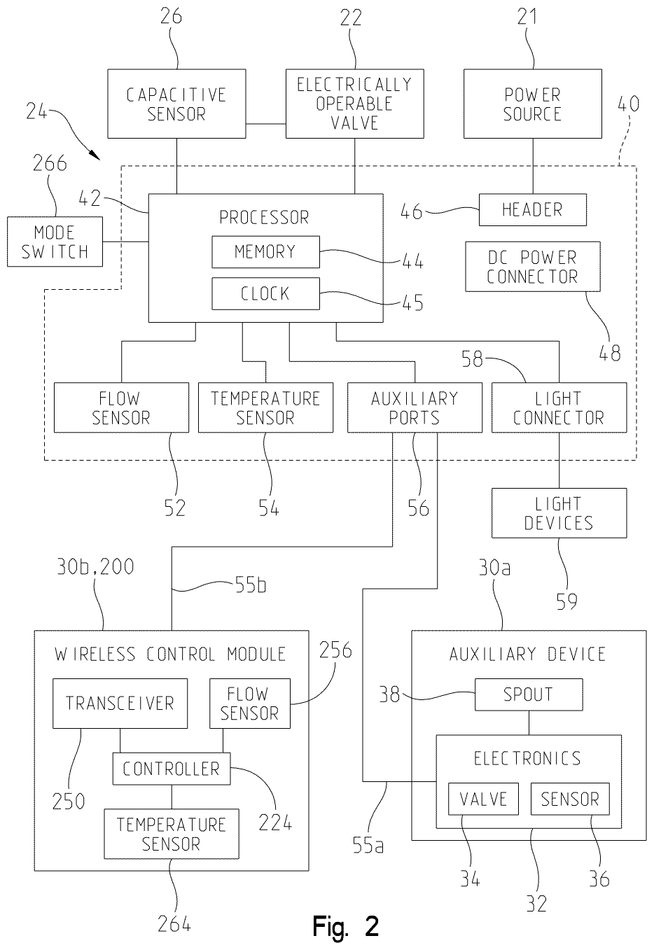

Exemplary electronically controlled mixing valves are described in U.S. Pat. No. 7,458,520 and PCT International Patent Application Publication No. WO 2007/082301, the disclosures of which are expressly incorporated by reference herein. The amount of fluid flowing from hot water source 16 and cold water source 18 may be controlled by valve controller 24 based on one or more user inputs, such as desired fluid temperature, desired fluid flow rate, desired fluid volume, various task based inputs, various recognized presentments, and/or combinations thereof. For example, faucet 10 may include a temperature sensor (e.g., temperature sensor 54 described herein) in fluid communication with the output of the proportioning valve to provide feedback to valve controller 24 for use in controlling the water temperature. In one illustrative embodiment, valve controller 24 controls the proportional valve via an auxiliary port 56 (FIG. 2) as further described herein.

In one illustrative embodiment, faucet 10 includes one or more indicators 29 controlled by valve controller 24 to provide a visual or audible indication of the operational mode (e.g., hands free and/or touch mode) and/or water temperature of the electronic faucet 10. An exemplary indicator 29 includes a light-emitting diode (LED) or other light source or audible device positioned near faucet 10. Other exemplary indicators 29 include a liquid crystal display (LCD) and a magnetically latching mechanical indicator. In one illustrative embodiment, indicators 29 are operative to indicate operating mode and/or the temperature of the water flowing through faucet 10 based on the selective illumination of different colored LED's or a single multi-colored LED.

In the illustrative embodiment, valve controller 24 may be in communication with a remote device in addition to electronic faucet 10, illustratively an auxiliary device 30. The exemplary auxiliary device 30 may include, for example, another faucet spout 30a (FIG. 2), a soap dispenser, a beverage dispenser, or another suitable dispensing device. The auxiliary device 30 may also comprise any of a garbage disposal, a dishwasher, an instant hot device, a remote switch (e.g., a foot switch), or other device associated with or in proximity to a plumbing device. As further detailed herein, the auxiliary device 30b (FIG. 2) may comprise a wireless communication device (e.g., a wireless control module). Auxiliary device 30 may be positioned adjacent the same sink basin as spout 12. Alternatively, auxiliary device 30 may be positioned to dispense into a different sink basin, such as another sink basin in a bathroom or kitchen or in another room, for example.

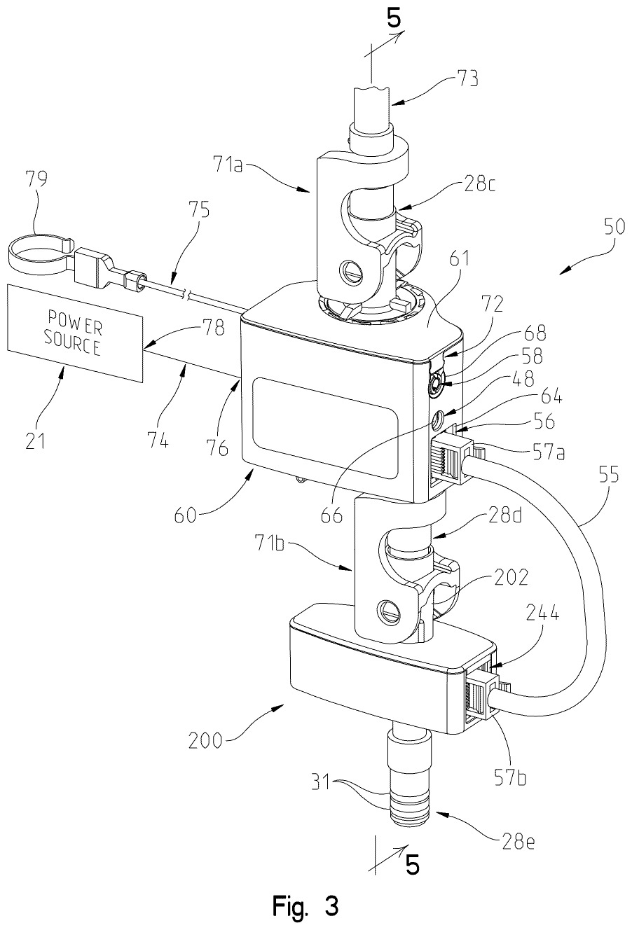

As described in further detail herein, valve controller 24 illustratively includes auxiliary port 56 (see FIGS. 2 and 3) for remotely controlling and/or powering the auxiliary device 30 via an electronic connector cable 55 (FIG. 3). The connector cable 55 may be of conventional design and, illustratively, comprises a serial cable including opposing first and second end connectors 57a and 57b, and providing for bidirectional communication, as further detailed herein. More than one auxiliary device 30a, 30b, etc. may be coupled to different auxiliary ports 56 by multiple electronic cables 55a, 55b. While the illustrative auxiliary device 30 may be fully controlled by valve controller 24, the device 30 may also include a separate controller (e.g., microprocessor) for operating itself, while receiving power and/or communication signals from the controller 24.

Referring further to FIG. 2, a block diagram of exemplary valve controller 24 of FIG. 1 is illustrated. Valve controller 24 illustratively includes a printed circuit board 40 and multiple circuit components mounted to the printed circuit board 40. Illustratively, a processor 42, a flow sensor 52, a temperature sensor 54, auxiliary port(s) 56, and a light connector 58 are coupled to circuit board 40. A connection header 46 is illustratively coupled to circuit board 40 for coupling a power line from an external power source 21. In one illustrative embodiment, power source 21 is a battery power supply or other direct current (DC) power supply connected at header 46. Internal or external memory 44 of processor 42 may include software and/or firmware containing instructions executed by processor 42 for controlling solenoid valve 22, other components of faucet 10, and other devices (e.g., auxiliary devices 30). A conventional clock 45 is illustratively in communication with the memory 44 for storing date and time information. Processor 42 illustratively controls solenoid valve 22 based on output from capacitive sensor 26, flow sensor 52, and/or temperature sensor 54.

Light connector 58 is configured to route electrical current to light devices 59, such as LED's for example, to illuminate light devices 59. In one illustrative embodiment, light devices 59 are different colors, and processor 42 selectively controls light devices 59 to illuminate different colors based on the operating mode of the faucet 10 and/or the temperature of the water flowing through faucet 10. An exemplary light connector 58 includes an audio jack connector. In one embodiment, indicators 29 of FIG. 1 include the light devices 59 of FIG. 2. In the exemplary embodiment, valve controller 24 also includes a power connector 48 for coupling valve controller 24 to a wall outlet or other building power supply to power valve controller 24. Power connector 48 illustratively includes a rectifier to convert alternating current (AC) power to DC power levels suitable for valve controller 24.

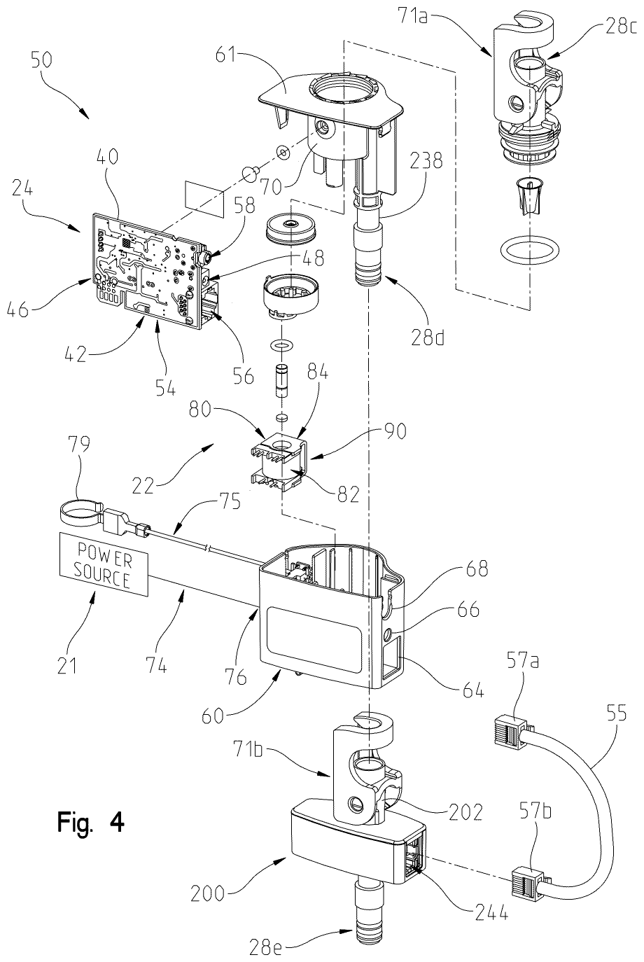

Referring to FIGS. 3-5, an exemplary solenoid valve assembly 50, including solenoid valve 22, is illustrated in fluid and electrical communication with a wireless control module 200. As further detailed herein, the wireless control module 200 is configured to receive and/or transmit wireless signals. Fluid enters a valve housing 70 (FIG. 4) of solenoid valve assembly 50 via fluid conduit 28c and exits valve housing 70 via fluid conduit 28d, then through wireless control module 200 and to spout 12 via fluid conduit 28c (FIG. 1). Fluid conduits 28d and 28e may include seals 31 (FIG. 3) providing a sealing connection to a mating component of the fluid conduit 28e and the fluid conduit of spout 12, respectively. Swing connectors or couplers 71a and 71b are illustratively pivotally supported for coupling together fluid conduit 28c with an inlet tube 73 from the manual valve assembly 20, and for coupling together fluid conduit 28d with a main body 202 of wireless control module 200.

Solenoid valve assembly 50 illustratively includes an outer housing 60 for enclosing and protecting valve controller 24 and solenoid valve 22 positioned within housing 60. Outer housing 60 is configured to slide over the top of valve housing 70 (FIG. 4) and mount to a base 61 of solenoid valve assembly 50. Clips 72 on opposite ends of base 61 are configured to engage outer housing 60, although other suitable fasteners may be used to couple outer housing 60 to base 61. Outer housing 60 includes an opening 62 for receiving fluid conduit 28d. Outer housing 60 further includes an opening 64 that provides access to auxiliary port 56, an opening 66 that provides access to DC power connector 48, and an opening 68 that provides access to light connector 58.

As illustrated in FIG. 4, valve controller 24 is mounted to valve housing 70 of assembly 50. A power cable 74 routes power from power source 21 to valve controller 24 for powering the electronic components of valve controller 24. Power cable 74 includes electrical wires routed between a connector end 76 configured to couple to header 46 of valve controller 24, and an opposite connector end 78 configured to couple to power source 21. Additional cable wires 75 may be provided to route sensor signals, such as from capacitive sensor 26, to valve controller 24. In an illustrative capacitive sensing embodiment, a contact clip 79 may be electrically coupled to a mounting shank of spout 12.

As illustrated in FIG. 4, a solenoid coil 80 of solenoid valve 22 includes coil wire 82 wound around a bobbin 84. In the illustrated embodiment, solenoid coil 80 is mounted directly to circuit board 40. A U-shaped metal bracket 90 is sized to fit over solenoid coil 80. Metal bracket 90 serves as a component for routing magnetic flux generated with solenoid coil 80. In particular, when solenoid coil 80 is energized by controller 24, bracket 90 provides a flow path for the generated magnetic flux. Additional details on an illustrative solenoid valve 22 are provided in U.S. Patent Application Publication No. 2016/0362877 to Thomas et al, the disclosure of which is expressly incorporated herein by reference.

Referring further to the FIG. 4, processor 42, header 46, temperature sensor 54, port 56, DC power connector 48, and light connector 58 are illustratively mounted to printed circuit board 40. Port 56, DC power connector 48, and light connector 58 are illustratively mounted at an edge of circuit board 40 to align with openings 64, 66, 68 of outer housing 60. Circuit board 40 includes other suitable electronics for controlling solenoid valve 22. Header 46 illustratively includes electrical pins configured to receive connector end 76 of power cable 74.

Auxiliary port 56 is configured to receive connector cable 55 routed to auxiliary device 30 (FIG. 2) that may be in communication with and powered by valve controller 24. Illustratively, the auxiliary device 30a may comprise the wireless control module 200. Connector cable 55 includes first end connector 57a that is releasably coupled to auxiliary port(s) 56. As such, a plug-and-play configuration is provided with auxiliary port(s) 56 that facilitates quick coupling and decoupling of secondary devices (e.g., auxiliary device 30) that are controllable with valve controller 24 of faucet 10. In one illustrative embodiment, more than one auxiliary device 30 is coupled to auxiliary port 56 and controlled by valve controller 24.

Referring again to FIG. 2, the control and power management software/firmware and control switches of valve controller 24 are illustratively used to control the operation of auxiliary device(s) 30. Auxiliary device 30 may include, for example, a soap dispenser, another faucet, a beverage dispenser, a filtered water dispenser, a hot water dispenser, or another suitable dispensing device. As illustrated in FIG. 2, auxiliary dispensing device 30a may include a spout 38 that supports a fluid supply conduit. Dispensing device 30a illustratively includes electronics 32 in communication with valve controller 24 including an electrically operable valve 34, such as a solenoid valve or electronically proportional valve (EPV), positioned in the fluid supply conduit for controlling fluid flow through spout 38. Electronics 32 are releasably coupled to auxiliary port 56 via the quick-coupling connector cable 55a routed between the faucet 10 and device 30a. In one embodiment, fluid flow through the auxiliary device 30a is controlled by processor 42 based on serial communication received from auxiliary device 30 (e.g., from a sensor 36) via port 56, similar to the capacitive-based controls of faucet 10. As further detailed herein, the auxiliary device 30a may also include a separate controller (not shown) in communication with valve 34 and/or sensor 36 to control operation thereof.

Valve controller 24 illustratively routes power received from power source 21 (FIG. 2) or DC power connector 48 to electronics 32 of auxiliary device 30 via port 56 to power device 30. As such, in one illustrative embodiment, both faucet 10 and the auxiliary device 30 operate off the same power source as managed by valve controller 24. Valve controller 24 is operative to receive inputs from auxiliary device 30, process the inputs, and output electrical signals for controlling the electronics 32 (e.g., solenoid, motor, lights, etc.) of device 30 based on the received inputs. In one illustrative embodiment, auxiliary device 30 includes at least one proximity sensor 36, such as a capacitive sensor or infrared sensor, operative to detect a user's hands on or near device 30, as similarly described herein with respect to capacitive sensor 26 of electronic faucet 10. Alternatively, auxiliary device 30 may include a switch device configured to instruct valve controller 24 to activate the device 30 upon actuation of the switch device by the user. Valve controller 24 may control fluid flow (e.g., water, soap, beverage, etc.) through auxiliary device 30 based on the received signals from the proximity sensor 36 or the switch device. Valve controller 24 is also operative to power display lights, such as LED's, on auxiliary device 30 corresponding to the various operational modes or states of device 30.

Accordingly, auxiliary device 30 may include a passive or dumb electrical interface with limited or no active controls wherein the electronics 32 of the interface are controlled remotely by valve controller 24 of faucet 10 via auxiliary port 56. In one illustrative embodiment, the circuitry of auxiliary device 30 includes the necessary circuitry for connecting the device 30 to valve controller 24, for detecting and sending an activation request to valve controller 24, and for actuating the fluid valve based on controls from valve controller 24. In other illustrative embodiments, the auxiliary device 30 may include a controller (e.g., a microprocessor) for operating itself, wherein the auxiliary device 30 only receives power and/or communication from the controller 24.

In one illustrative example, auxiliary port 56 includes a multi-pin (e.g., 8 pin) registered jack (RJ) receptacle, although any suitable electrical connector may be used for port 56. In one illustrative embodiment, the multiple pin connections of auxiliary port 56 include a switched power supply connected to battery voltage (e.g., power source 21) for powering electronics of auxiliary device 30, a ground line, a serial data transmit line, a serial data receive line, an interrupt line, a 3.3 volt power line, and a reset line.

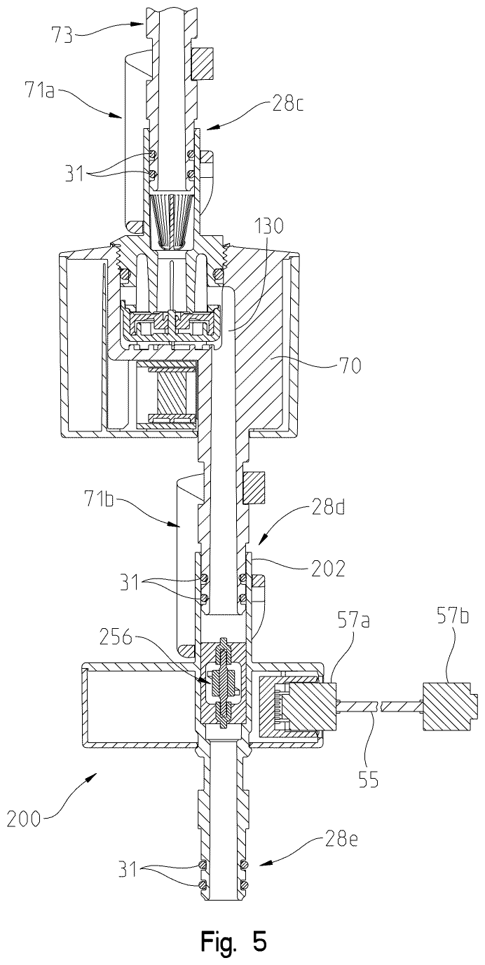

Temperature sensor 54 may be mounted (e.g., soldered) directly to circuit board 40. As such, sensor 54 is illustratively positioned outside of valve housing 70. In one illustrative embodiment, temperature sensor 54 includes a surface-mount type NTC thermistor soldered to circuit board 40, although other suitable temperature sensors may be used. A heat transfer device extends from temperature sensor 54 to inside an interior region or waterway 130 (FIG. 5) of valve housing 70. Heat transfer device is operative to transfer heat from the fluid within interior region 130 of valve housing 70 to temperature sensor 54, as described herein.

Illustratively, processor 42 is operative to control faucet 10 based on the water temperature measured with temperature sensor 54. In one illustrative embodiment, processor 42 is operative to selectively control light devices 59 (FIG. 2) to illuminate different colored devices 59 to indicate the water temperature to the user. For example, blue indicates cold water, red indicates hot water, and shades between red and blue indicate temperatures between hot and cold. Alternatively, processor 42 illustratively displays the water temperature numerically on a digital or analog display (e.g., an LCD display of indicator 29). In one illustrative embodiment, valve controller 24 is programmed to shut off water flow, i.e., close solenoid valve 22, automatically upon the detected water temperature exceeding a threshold temperature. An exemplary threshold temperature is about 120 degrees Fahrenheit, although other suitable thresholds may be set. In one embodiment, controller 42 uses the temperature information from sensor 54 to control an electrically operable mixing valve (e.g., valve 20) in series with solenoid valve 22. The mixing valve is controlled to mix water proportionally from hot and cold sources 16 and 18 to achieve a desired temperature. The desired temperature may be selectable by the user or may be predetermined and programmed in memory of processor 42. As such, closed loop temperature control of the water through faucet 10 may be provided with temperature sensor 54. Other suitable controls may be implemented based on water temperature.

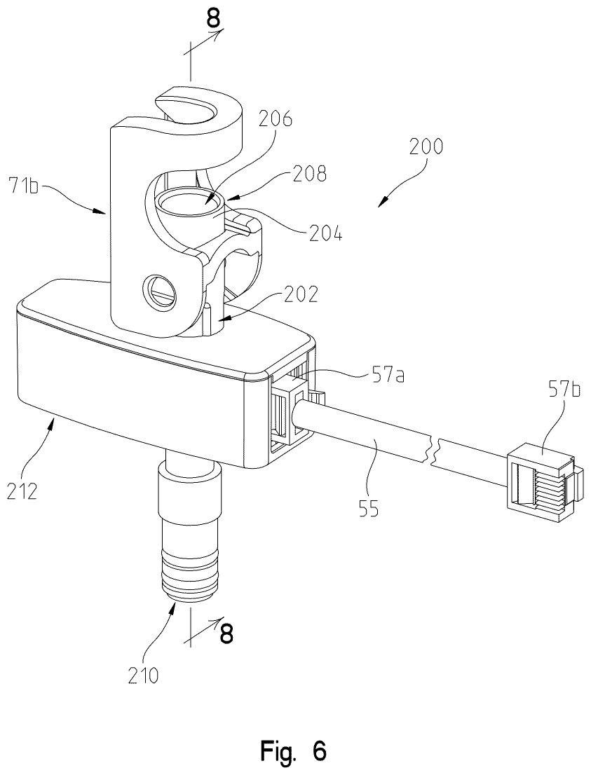

With reference to FIGS. 6-8, the illustrative wireless control module 200 includes a main body or waterway tube 202 including a tube 204 defining a waterway or fluid passageway 206 extending between an inlet 208 and an outlet 210. The main body 202 may be formed from a polymer, such as a glass fiber reinforced thermoplastic material. A housing or cover 212 is coupled to the main body 202. More particularly, an end wall 214 of the main body 202 is coupled to an open end 216 of the housing 212. The housing 212 may be formed from a polymer, such as an acetal copolymer. An inlet portion 218 of the tube 204 extends in a first direction from the end wall 214, and an outlet portion 220 of the tube 204 extends in a second direction, opposite the first direction, from the end wall 214. A chamber 222 is defined within the housing 212 and receives a wireless controller 224. The outlet portion 220 of the tube 204 extends through the chamber 222 and out of the housing 212 via an opening 226 in an end wall 228.

The inlet 208 is fluidly coupled to the outlet 28d of the solenoid valve assembly 22, and the outlet 210 is fluidly coupled to water outlet 19 of spout 12. More particularly, the inlet portion 218 of the tube 204 receives the outlet tube 28d of the solenoid valve assembly 22. The swing clip 71b illustratively secures the outlet tube 28d of the solenoid valve assembly 22 to the tube 204 of the wireless control module 200. More particularly, a first end 230 of the swing clip 71b is pivotably coupled to pins 232 on the inlet portion 218 of the tube 204. A second end 234 of the swing clip 71b includes an arcuate retainer 236 configured to engage an annular recess 238 on the outlet tube 28d. The outlet portion 220 of the tube 204 is illustratively received within an end of fluid conduit 28e coupled to the spout tube 12. O-rings 31 may be positioned intermediate the tube 204 and the fluid conduit 28e to provide fluid sealing therebetween.

The wireless controller 224 illustratively includes a printed circuit board 240 received within the chamber 222 of the housing 212. The printed circuit board 240 illustratively supports a conventional microprocessor 242. An auxiliary port 244 may also be supported by the printed circuit board 240 and is in electrical communication with the wireless controller 224. The auxiliary port 244 is accessible through an opening 246 in a side wall 248 of the housing 212.

A wireless communication device, such as a wireless transceiver 250, is illustratively supported by the printed circuit board 240 and is in electrical communication with microprocessor 242 of the wireless controller 224. The wireless transceiver 250 is configured to wirelessly communicate (e.g., receive and/or transmit wireless signals, either directly or indirectly) with a remote device 252. Such wireless communications may be via known technologies, such as wireless communications in the 2.4 GHz frequency band including, for example Wi-Fi, ZigBee, and Bluetooth (e.g., Bluetooth Low Energy (BLE)). The wireless transceiver 250 illustratively comprises a wireless radio and antenna, such as a Wi-Fi module or chip, a ZigBee module, or a Bluetooth module. In one illustrative embodiment, the wireless transceiver 250 comprises a Wi-Fi chip configured to be in communication with a Wi-Fi network 254. As detailed herein, the wireless communication device illustratively comprises transceiver 250 for both receiving and transmitting wireless signals. In other words, transceiver 250 is understood to include both a receiver and a transmitter. As such, a receiver may be defined by a transceiver and, more particularly, by transceiver 250 embedded with the printed circuit board 240. Use of the term receiver is not limited to a device that only receives signals, and may include a device that also transmits signals (e.g., a transceiver).

The remote device 252 may comprise a scheduler and conversion device in wireless communication with the transceiver 250 of the wireless control module 200. Alternatively, the remote device 252 may comprise a smart phone, a tablet, a computer and/or a dedicated remote user interface (i.e., remote control). As further detailed herein, the remote device 252 may communicate over the Internet through the cloud to the wireless control module 200. In yet other illustrative embodiments, the remote device 252 may include both a voice recognition and conversion device, and at least one of a smart phone, a tablet, a computer and/or remote control.

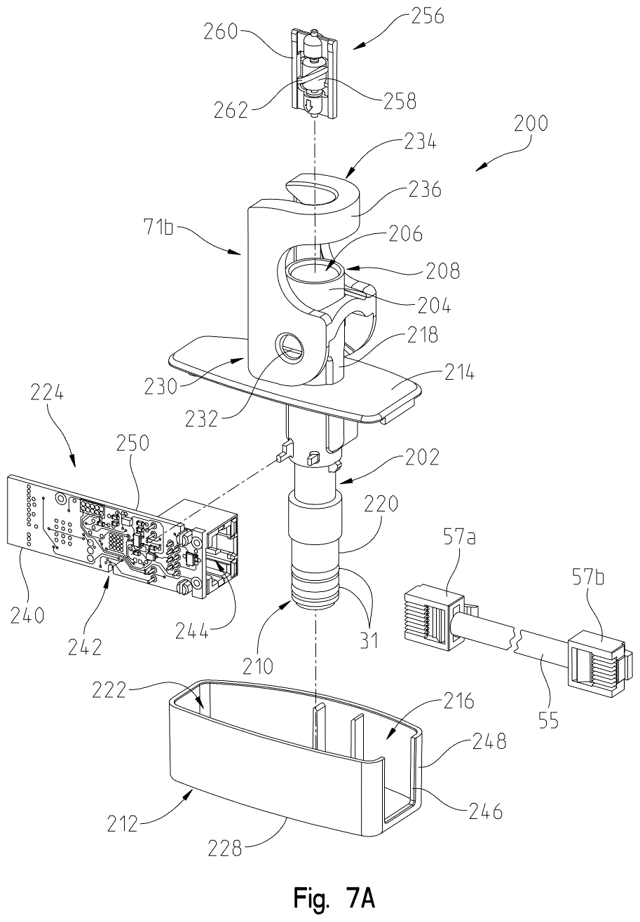

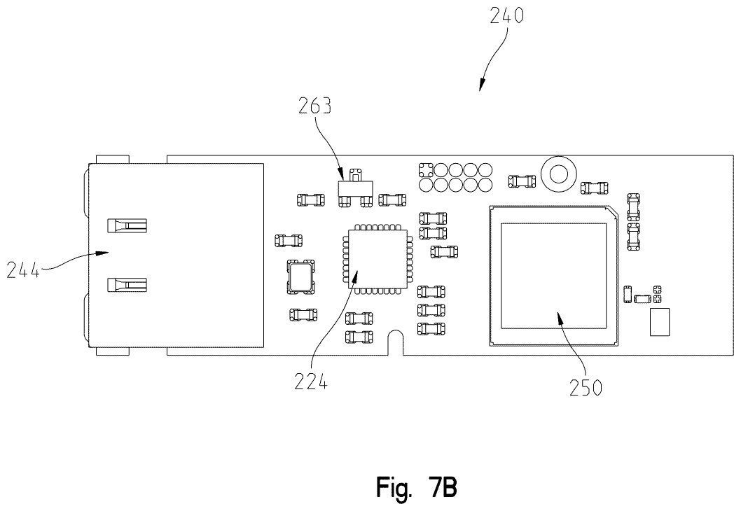

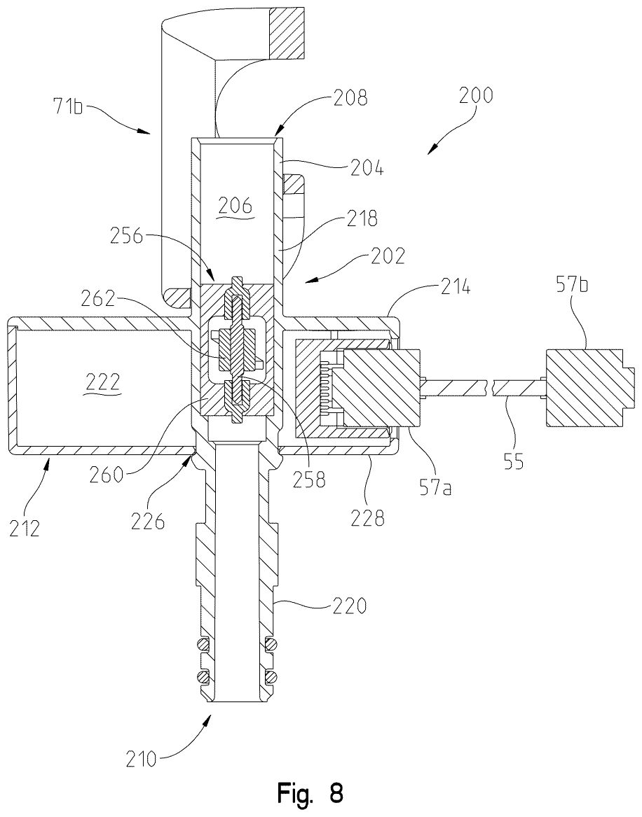

With reference to FIGS. 2 and 8, a flow sensor 256 is illustratively supported by the tube 204 of the main body 202 to detect water flow within the fluid passageway 206, and is in electrical communication with the wireless controller 224 and/or the valve controller 24. More particularly, the flow sensor 256 illustratively comprises a flow turbine assembly 257 including a flow turbine 258 supported for rotation by a flow turbine cage 260. The flow turbine cage 260 may be received within the tube 204 such that water flow through the fluid passageway 206 rotates the flow turbine 258. The flow turbine 256 may be a magnetic flow turbine including a magnet supported by rotor 262 and a sensor or detector 263 supported on the printed circuit board 240 (FIG. 7B), the detector 263 being configured to detect rotation of the rotor 262. The number of rotations detected by the sensor 263 is correlated to flow rate and/or flow volume by the wireless controller 224 and/or the valve controller 24. The valve controller 24 may control the electrically operable valve 22 to dispense a predetermined amount of water based upon the input from the flow sensor 256. Additionally, the flow sensor 256 may be used to monitor water use and provide such information to the user. More particularly, water usage information from the flow sensor 256 may be provided to the controller 224, and transmitted from the embedded transceiver 250 to the processor 42 for displaying to the user information on water consumption of the faucet 10 over time, for example on a display screen (not shown).

In certain illustrative embodiments, a temperature sensor 264 may be supported by the tube 204 of the main body 202 to detect the temperature of water flowing through the fluid passageway 206, and is in electrical communication with the wireless controller 224 and/or the valve controller 24. Temperature sensor 264 may supplement or replace temperature sensor 54 of the valve assembly 20. As further detailed herein, the temperature sensor 54 may be used with the wireless controller 224 and/or the valve controller 24 to provide a temperature indication to the user, provide a high temperature limit and/or provide a warm-up feature.

Wireless controller 224 illustratively provides a means for reading flow sensor 256, temperature sensor 264 and wireless communication device 250, such as Wi-Fi chip, ZigBee module, or Bluetooth module for receiving and/or transmitting data. Electronic cable 55 communicates commands (e.g., signals) between the wireless control module 200 and the electronic control valve 20 via the valve controller 24. Illustratively, the electronic cable 55 is a serial cable including opposing first and second end connectors 57a and 57b. The first connector 57a is coupled to the port 56 of the valve controller 24, while the second connector 57b is coupled to the port 244 of the wireless control module 200.

The modular waterway design detailed herein permits the wireless control module 200 to be inserted between the outlet of the electronic control valve 20 and the waterway extending through faucet spout 12. It should be appreciated that additional user interfaces may be operably coupled to the valve controller 24 and/or the wireless controller 224. For example, and as further detailed herein, a user input (e.g., mode switch 266) may be in electrical communication with the valve controller 24.

A serial communication protocol illustratively exists between the wireless controller 224 of the wireless control module 200 and the processor 42 of the valve controller 24. Serial communication between the wireless controller 224 and the processor 42 is configured to occur bi-directionally. In addition to transmit and receive data signals, an interrupt signal may be used to indicate to the recipient that a data transmission is about to begin. The interrupt signal allows both the wireless control module 200 and the processor 42 of the valve controller 24 to go into low-power sleep modes until one is woken-up, or activated, by the other using the interrupt signal. This scheme or protocol allows for both devices 200, 42 to operate for long periods of time on battery power; as they are not always fully powered-up waiting or searching for data. The serial protocol to send data may be uniquely defined and register based. For example, to set the water state an auxiliary device or smart spout can write the value of ‘to register 0x02 to turn on (e.g., open) the valve 22. As another example, an auxiliary device 30 can request the current water temperature by requesting the value currently stored in register 0x05 in the valve controller 24. Illustratively, all serial message packets use a start byte, a stop byte, a message length byte and two byte cyclic redundancy check (CRC) to ensure data integrity.

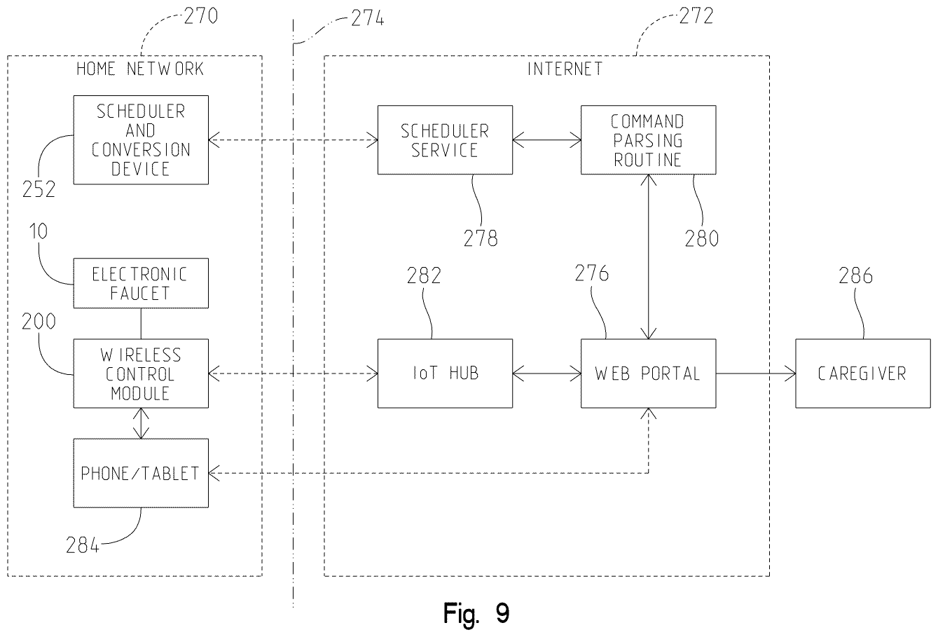

FIG. 9 is a diagrammatic representation of illustrative internet communication with the wireless control module 200. More particularly, the scheduler and conversion device 252 and the wireless control module 200 may be part of a home network 270 that communicates wirelessly with software stored within the internet 272 (e.g., internet cloud) via a web interface 274. The web interface 274 may be of conventional design, such as a wireless router or hub, for facilitating communication between the internet cloud 272 and the home network 270. A web portal 276 illustratively provides communication between a scheduler service 278 and a command parsing routine 280, and an internet of things (IoT) hub 282. Additionally, a dedicated remote use interface, such as a smart phone or tablet 284, may be in communication with the web portal 276. In another illustrative embodiment, the smart phone or tablet 284 can communicate directly with the wireless control module 200, for example, via a Soft A Wi-Fi configuration.

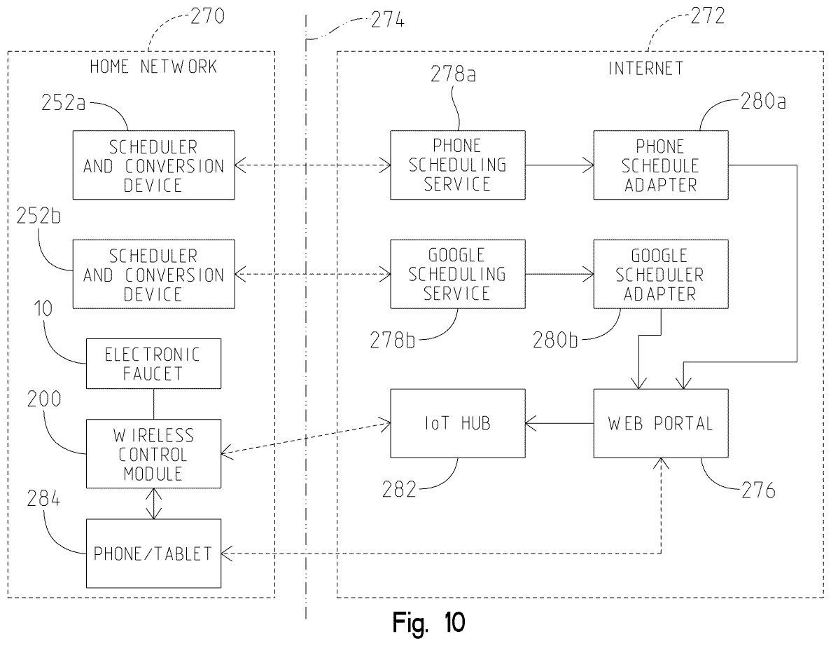

FIG. 10 is a diagrammatic representation of illustrative internet protocols for use with the wireless control module 200. For example, scheduler and conversion device 252a may comprise, for example, a phone schedule service such as a calendar for use on devices (e.g., mobile phones) available from Apple of Cupertino, California USA, or any Android devices. In such an illustrative embodiment, the device 252a is in communication with a phone schedule service 278a and phone schedule adapter 280a. In another illustrative embodiment, scheduler and conversion device 252b may comprise, for example, a web scheduler such as a calendar, available from Google of Mountain View, California USA. In such an illustrative embodiment, the device 252b is in communication with Google Calendar 278b and Google scheduler adapter 280b (e.g., Google cloud function).

The addition of the scheduler 252 to faucet 10 can provide further benefits to the user. Features like enabling or disabling faucet 10 according to a schedule table 278a or 278b (e.g. electronic calendar) may have an impact in residential and commercial faucet installations. However, scheduling with current electronic faucets is not feasible. The interface to enter and maintain a schedule is not present. As such, this feature is missing in current electronic faucets and not possible in a mechanical faucet. However, once connected to a wireless network (e.g., Wi-Fi), illustrative faucet 10 can be configured to enter and maintain scheduled features.

With this wireless connectivity, the user can enter and maintain scheduled features as desired, thereby defining different modes of operation. Once selected, scheduled features can be locally or remotely managed. Solenoid valve assembly 50 can communicate with scheduler 252 to correctly execute the set faucet scheduled feature. For example, faucet 10 (e.g., solenoid valve 22) may be deactivated when a user will be away from home (e.g., on vacation), or when a commercial building is unoccupied (e.g., after defined work hours).

An illustrative example of a set faucet scheduled feature is a holiday mode. This holiday mode may restrict use of certain features of the electronic faucet during religious holidays, such as during Jewish holidays. Illustratively, a Sabbath mode, also known as Shabbos mode (Ashkenazi pronunciation) or Shabbat mode, is a feature in many modern home appliances, including ovens and refrigerators, which is intended to allow the appliances to be used (subject to various constraints) by Shabbat-observant Jews on the Shabbat and Jewish holidays.

However, the Sabbath mode does not work with traditional electronic faucets. Electronic faucets typically have safeguards built in such that any flow of water through their system will time out after a predetermined duration, stopping flow of water through the associated home plumbing. Additionally, certain features are purely electronic in nature, such as temperature monitoring. This make a Sabbath mode difficult to implement in a traditional electronic faucet.

However, once connected to Wi-Fi, the illustrative electronic faucet 10 can be configured to include a holiday mode. For example, the illustrative electronic faucet 10 may be “set” for Sabbath mode operation. A main feature would be the connection to the internet for determination of the start and end times of the Sabbath mode.

With this connectivity the user can determine if the Sabbath mode is desired. If selected, the connectivity can be used to defeature the electronic faucet 10 (i.e., disable certain features) only during the correct times. As mentioned above, the Wi-Fi enabled solenoid valve assembly 50 can communicate to scheduler 252 to correctly determine the faucet feature setting: full feature during non-Sabbath times and restricted feature during the Sabbath.

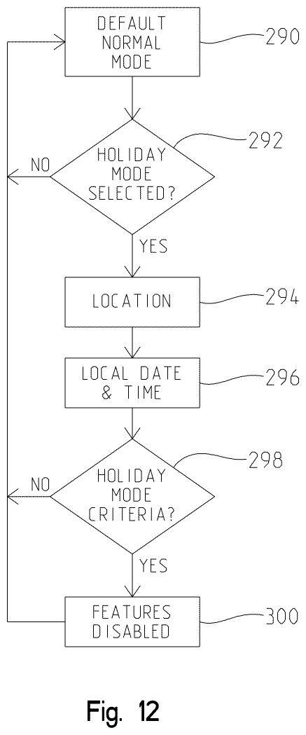

With reference to FIG. 12, an illustrative holiday mode of operation is shown. The illustrative electronic faucet 10 starts with a default normal mode 290 providing unrestricted faucet features. If a holiday mode is not selected at block 292, the electronic faucet 10 remains in the default normal mode at block 290. If the holiday mode is selected at block 292 (for example, via user input mode switch 266 or another user interface (local or remote)), then the electronic faucet 10 proceeds to block 294 where location information is input to the valve controller 24. This may be provided to the memory 44 of the processor 42 from an external source (e.g., a wireless connection) or manually input by the user. At block 296, current local date and time data may be provided to the controller 24. This may be provided to the memory 44 of the processor 42 from an external source (e.g., a wireless connection), from the clock 45 of the processor 42, or manually input by the user.

At decision block 298, the processor 42 decides if the holiday mode criteria should be applied by comparing the location data, and the respective current local date and time data to the holiday date and time (e.g., Sabbath date and time) from the calendar 253 of the scheduler 252. If holiday mode criteria should be applied based upon the selection at block 292, the location data from block 294 and the current local date and time data from block 296, then the electronic faucet 10 will proceed to block 300 where certain features are disabled. Illustratively, operation of the solenoid valve 22 is disabled. If the holiday mode criteria is not set at block 298, then the electronic faucet 10 returns to the default normal mode of operation at block 290.

Yet another set faucet scheduled feature could include a night light control mode of operation. Using the base indicator 29 of an electronic faucet 10 as a night light is known. A problem has been when to turn the night light on and off. A sensor to determine ambient light may be difficult and visually unappealing on a faucet. Additionally, setting an on time and duration has proven difficult on a traditional electronic faucet.

However, electronic faucet 10 with wireless communication could be configured to accomplish a time schedule to control a night light. The Wi-Fi enabled solenoid valve assembly 50 can communicate with the scheduler 252 and control the light 29. More particularly, the processor 42 may compare current local date and time data from the memory 44 to set date and time data from the calendar 253 of the scheduler 252, to determine when to turn the night light 29 on and off.

Additionally, a notable issue which users can encounter is the risk of having home plumbing pipes freeze in extreme cold situations. In order to prevent freezing pipes, users often set their faucet valve handles to allow some amount of water to drip into the sink, which provides sufficient flow of water through the associated home plumbing. However, this freeze protection setting of a faucet does not work with conventional electronic faucets. Electronic faucets typically have safeguards built in such that any flow of water through their system will time out after a prescribed duration, stopping flow of water through the associated home plumbing. Additionally, some electronic faucets lack a manual valve handle to allow a dripping amount of water to be “set”.

The present disclosure allows the illustrative electronic faucet 10 to be “set”, providing sufficient flow of water to prevent associated supply pipes or lines 28a, 28b from freezing. Additionally, the illustrative electronic faucet 10 of the present disclosure can be combined with wireless (e.g., WiFi) connected local weather forecasting to allow this “setting” to occur automatically, based upon the user's desired outside temperature level.

One option, via software implementation, is an algorithm which regulates the flow of water through faucet 10, at a given temperature, which can be user-configured via a smartphone application (app). As solenoid valve assembly 50 also includes access to Wi-Fi, the device can be programmed to monitor local temperature (via communication with a weather app, for example), and control the faucet dispensing as needed, based upon a pre-determined external temperature setting.

The Wi-Fi enabled solenoid valve assembly 50 can communicate with a local weather app, and enact freeze protection dispensing of water through the homeowner's water system. WiFi/BLE communications also allow access to solenoid valve assembly 50 by the end-user, so that it can be configured to that user's desires-including water dispensing duration, frequency, etc., as well as minimal external temperature to enact dispensing.

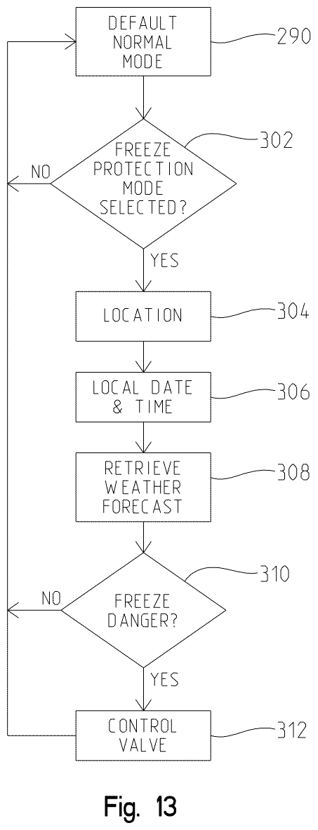

With reference now to FIG. 13, an illustrative freeze protection mode of operation is illustrated. Again, the electronic faucet 10 begins at block 290 in the default normal mode of operation. If a freeze protection mode is not selected at block 302, the electronic faucet 10 remains in the default normal mode at block 290. If the freeze protection mode is selected at block 302 (for example, via user input mode switch 266 or other user interface (local or remote)), then the electronic faucet 10 proceeds to block 304 where location information is input to the valve controller 24. This may be provided to the memory 44 of the processor 42 from an external source (e.g., a wireless connection) or manually input by the user. At step 306, current local date and time data may be provided to the controller 24. This may be provided to the memory 44 of the processor 42 from an external source (e.g., a wireless connection), from the clock 45 of the processor 42, or manually input by the user.

At block 308, the electronic faucet 10 may retrieve weather forecast information, including predicted temperature data, from a wireless connection. Alternatively, the electronic faucet 10 may retrieve temperature data from a local temperature sensor. At block 310, the processor 42 makes a decision as to whether there is a freeze danger based upon the weather forecast and/or current temperature retrieved at block 308. More particularly, the processor 42 decides if the freeze protection mode criteria should be applied by the processor 42 by comparing the location data, and the local date and time data to the forecast information from the scheduler 252. If there is a danger, then the controller 24 controls the solenoid valve 22 to provide selective water flow to prevent freezing of water supply pipes 28a, 28b at block 312. If there is no freeze danger at block 310, then the electronic faucet 10 returns to the default normal mode of operation at block 290. At block 312, the valve controller 24 operates the solenoid valve 22 at predetermined times and for predetermined durations to allow water to flow through the supply pipes 28a, 28b to prevent water freezing.

Another set faucet scheduled feature could include an aging-in-place function or mode of operation. A person living alone can have problems that go undetected by others. Illustrative electronic faucet 10 would keep track of how long it has been since its last use to detect a potential problem. A Wi-Fi connected faucet 10 could be set to determine if a predetermined time has elapsed since the last use and notify a remote entity (e.g, a caregiver) of a potential issue.

Illustrative electronic faucet 10 could use the Wi-Fi connection to determine time and send notifications to entities at predetermined addresses. The Wi-Fi enabled solenoid valve assembly 50 can communicate to a time date server and determine if a message should be sent.

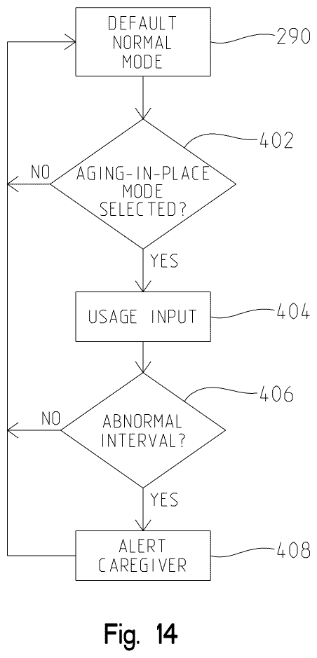

With reference to FIG. 14, an aging in place mode of operation is illustrated as beginning with the default normal operation at block 290. If an aging-in-place mode is not selected, the electronic faucet 10 remains in the default normal mode at block 290. If the aging-in-place mode is selected at block 402 (for example, via user input mode switch 266 or other user interface (local or remote)), then the electronic faucet 10 proceeds to block 404 where usage input is provide to the valve controller 24. More particularly, historical data of electronic faucet use (e.g., dates, times and durations of operation of electrically operable valve 22) is illustratively stored in the memory 44 of the processor 42. Illustratively, this usage data may be provided to the memory 44 of the processor 42 by the flow sensor 52. At block 406, current local date and time data may be provided to the controller 24. This may be provided to the memory 44 of the processor 42 from an external source (e.g., a wireless connection), from the clock 45 of the processor 42, or manually input by the user.

At block 406, the processor 42 compares historical usage to recent usage. If an abnormal interval between historical and current faucet usage is determined, then the electronic faucet 10 may alert an entity (e.g, a caregiver) at block 408. For example, the controller 24 is configured to detect and report a problem after a predetermined amount of time has lapsed since the last use of the solenoid valve 22 of the faucet 10. The predetermined amount of time may be calculated by the processor 42 based upon the stored historical faucet usage. Again, the current usage data may be detected by the flow sensor 52 and provided to the processor 42. The transceiver 250 of the wireless control module 30b, 200 may wirelessly transmit an alert (e.g., via the internet, email, phone, etc.) to contact information (e.g., email address, telephone number, etc.) stored in the memory 44. For example, contact information related to the electronic faucet 10 (user name, address, etc.) may be wirelessly transmitted to a caregiver. If no abnormal interval is detected, the electronic faucet 10 returns to the default normal mode at block 290.

With further reference to FIGS. 9 and 10, setup of the internet of things (IoT) hub 282 for communication with the controller 224 of the wireless control module 200 is illustratively provided by using only a webpage from a remote computing device, such as smart phone or tablet 284. More particularly, communications between the wireless control module 200 and the voice recognition and conversion device 252 are illustratively provided over the Wi-Fi network 270 and the internet 272 using standard internet protocols. A setup mechanism is provided for connecting the device 200 to the internet 272 without requiring the user to download a stand-alone application from a dedicated application store (e.g., the Apple App Store or Google Play Store).

Illustrative steps to setup device (e.g., wireless control module 200) are detailed below. The advantage of this setup system is that the user can use the web browser in his or her smart phone or tablet 284 to setup the device 200 without having to download a stand-alone ‘app’ for this one-time setup. In addition to the streamlined setup of the device 200, future configuration and control of the device 200 can occur thru a web portal, again employing the use of a built-in web browser in the user's smart phone or tablet 284. An illustrative Wi-Fi web setup procedure includes the following steps:
1. The device 200 will host its own Webserver and software access point (soft AP).
2. The user will connect to this soft AP by selecting this open Wi-Fi network on his or her smart phone or tablet 284.
3. The user will open his or her web browser and type in the IP address or url to the locally hosted webpage.
4. In the soft AP webpage, the user will be asked to select his or her home Wi-Fi SSID and enter his or her passkey.
5. At this point, the soft AP will shut down and the device will attempt to connect to the home Wi-Fi network 270 using the credentials the user entered. While this is happening, the webpage on the user's smart phone or tablet 284 will use asynchronous JavaScript (AJAX) to delay ˜20 seconds (allowing the user's smart phone or tablet 284 to revert back to a stable internet connection on Wi-Fi or cellular) and then redirect to a globally resolvable web portal.
6. Once at the public web portal, the user will create an account to link his or her physical device (e.g. Wi-Fi voice faucet 10) to his or her account in the cloud.
7. Set-up finished. The user can now go back to the public web portal at any time to change settings for their device or remotely control their device (e.g., electronic faucet 10).

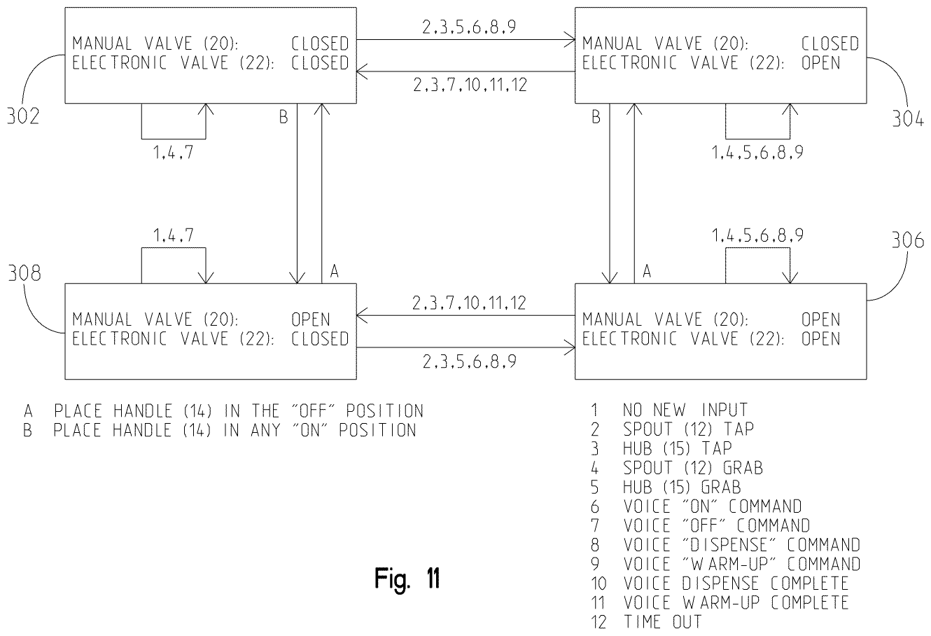

FIG. 11 is a state diagram showing an illustrative operation of the electronic faucet 10 of the present disclosure. Blocks 302, 304, 306 and 308 represent different operating states or modes of the illustrative electronic faucet 10. More particularly, block 302 represents a first state or mode of operation, where both the manual valve 20 and the electrically operable valve 22 are closed such that no water flows through the outlet 19 of the spout 12. Block 304 represents a second state or mode of operation, where the manual valve 20 is closed and the electrically operable valve 22 is open. No water flows through the outlet 19 of the spout 12 in the second mode of operation. Block 306 represents a third state or mode of operation, where both the manual valve 20 and the electrically operable valve 22 are open such that water flows through the outlet 19 of the spout 12. Block 308 represents a fourth state or mode of operation, where the manual valve 20 is open and the electrically operable valve 22 is closed. No water flows through the outlet 19 of the spout 12 in the fourth mode of operation.

In FIG. 11, various illustrative commands for controlling operation of the electrically operable valve 22 are represented by lines associated with various combinations of numbers 1 through 12. As further detailed herein, the valve controller 24 may receive commands from different inputs, such as capacitive sensor(s) 26 and/or scheduler and conversion device 252. The valve controller 24 may also distinguish between a “tap” and a “grab” of different components of the electronic faucet 10 as a result of signals received from capacitive sensor(s) 26. More particularly, the valve controller 24 may make such a distinction based on the amount of time between positive and negative slopes of the capacitive signal. A longer duration indicates a “grab”, while a shorter duration indicates a “tap”. Illustratively, a grab is a contact or touch lasting at least 300 milliseconds, while a tap is a contact or touch lasting no more than 300 milliseconds. Additional illustrative details on distinguishing between touching of a spout 12 and/or a handle 14 to define a tap and a grab, identifying different patterns of touching, and implementing different functions as a result thereof, are disclosed in U.S. Pat. No. 8,776,817 to Sawaski et al., U.S. Pat. No. 8,613,419 to Rodenbeck et al., U.S. Pat. No. 8,561,626 to Sawaski et al., the disclosures of which are expressly incorporated herein by reference.

With further reference to the state diagram of FIG. 11, command 1 is no new input. Command 2 is spout tap, where the user touches the spout 12 of the faucet 10 for a predetermined time defining a tap. Command 3 is a hub tap, where the user touches the hub 15 of the faucet 10 for a predetermined time defining a tap. Command 4 is a spout grab, where the user touches the spout 12 for a predetermined time defining a grab. Command 5 is a hub grab, where the user touches the hub 15 for a predetermined time defining a touch. Command 6 is a voice ON command, where the user voices an audible “on” to the voice recognition and conversion device 252. Command 7 is a voice OFF command, where the user voices an audible “off” to the voice recognition and conversion device 252. Command 8 is a voice DISPENSE command, where the user voices an audible “dispense” to the voice recognition and conversion device 252. Command 9 is a voice WARM-UP command, where the user voices an audible “warm up” to the voice recognition and conversion device 252. Command 10 is a voice dispense complete command, which is initiated after the voice DISPENSE command (command 8), where the controller 24 moves the electrically operable valve 22 to a closed position following the dispensing of a predetermined amount of water as measured by the flow sensor 256. Command 11 is a warm-up complete command, which is initiated after the voice WARM-UP command (command 9), where the controller 24 moves the electrically operable valve 22 to a closed position after the water temperature as measured by the temperature sensor 264 exceeds a predetermined value. Command 12 is a time out command, where the controller 24 moves the electrically operable valve 22 to a closed position after the electrically operable valve 22 has been opened for a predetermined time.

With further reference to FIG. 11, illustrative manual inputs to the handle 14 of the manual valve 20 are represented by lines associated with letters A and B. Manual input A is placing the handle 14 of the manual valve 20 in an OFF position, such that no water flows through the manual valve 20. Manual input B is placing the handle 14 of the manual valve 20 in an ON position, such that water flows through the manual valve 20.

Commands for controlling operation of the electrically operable valve 22 may be initiated through a variety of inputs associated with the electronic faucet 10. Such inputs may include one or more of scheduler, capacitive sensing, infrared (IR) sensing, proximity sensing, etc. Once a command is issued, the execution of the command illustratively occurs by using the controller 24 to keep track of elapsed time and reading of the sensors (e.g., flow sensor 52, 256, temperature sensor 54, 264, etc.) to control water flow. For capacitive sensing, the user may perform a touch sequence on a component of the electronic faucet 10 (e.g., a double tap on the spout 12), or combination touches on different components of the electronic faucet 10 (e.g., grab the spout 12 and move the manual handle 14 to hot, hold the spout 12 and double tap the manual handle 14, etc.).

In the operation illustrated in the state diagram of FIG. 11, the electronic faucet 10 may be controlled by commands input from both capacitive sensor(s) 26 and voice recognition supplied to the wireless control module 200. Beginning at state 302, commands 2 (spout tap), 3 (hub tap), 5 (hub grab), 6 (voice ON), 8 (voice DISPENSE), and 9 (voice WARM-EIP), will cause the controller 24 to open the electrically operable valve 22 while the manual valve 20 remains closed. As such, the electronic faucet 10 is in state 304. The electronic faucet 10 remains in state 302 in response to commands 1 (no new input), 4 (spout grab), and 7 (voice OFF).

The electronic faucet 10 remains in state 304 in response to commands 1 (no new input), 4 (spout grab), 5 (hub grab), 6 (voice ON), 8 (voice DISPENSE), and 9 (voice WARM-FTP). Commands 2 (spout tap), 3 (hub tap), 7 (voice OFF), 10 (voice DISPENSE), 11 (voice warm-up complete) and 12 (time out) return the electronic faucet 10 to state 302. From state 302, moving the manual handle 14 to the ON position (manual input B) causes the electronic faucet 10 to move to state 308.

From state 304, moving the manual handle 14 to the ON position (manual input B) causes the electronic faucet 10 to move to state 306. By moving the manual handle 14 back to the OFF position (manual input A), the electronic faucet 10 returns to state 304. At state 306, commands 2 (spout tap), 3 (hub tap), 7 (voice OFF), 10 (voice dispense complete), 11 (voice warm-up complete), and 12 (time out), will cause the controller 24 to close the electrically operable valve 22 while the manual valve 20 remains open. As such, the electronic faucet 10 is in state 308. The electronic faucet 10 remains in state 306 by commands 1 (no new input), 4 (spout grab), 5 (hub grab), 6 (voice ON), 8 (voice DISPENSE), and 9 (voice WARM-UP). Commands 2 (spout tap), 3 (hub tap), 5 (hub grab), 6 (voice ON), 8 (voice DISPENSE), and 9 (voice WARM-UP), return the electronic faucet 10 from state 308 to state 306.

The electronic faucet 10 remains in state 308 by commands 1 (no new input), 4 (spout grab), and 7 (voice OFF). From state 308, moving the manual handle 14 to the OFF position (manual input A) causes the electronic faucet 10 to move to state 302. By moving the manual handle 14 back to the ON position (manual input B) at state 302, the electronic faucet 10 returns to state 308.

It should be appreciated that a variety of different commands may be programmed for operation by the controller 24. For example, in response to a “wash hands” command, the controller 24 may (1) open the electrically operable valve 22 for a short, preset duration for the user to wet his hands, (2) close the electrically operable valve 22 for a short, preset duration for the user to apply soap, and (3) again open the electrically operable valve 22 for the user to rinse his hands. The controller 24 can again close the valve 22 after a short, preset duration, or only after an additional command input from the user. In this operation, the water dispensed may be set at a predetermined warm temperature (e.g., as detected by temperature sensor 54).

In response to a “brush teeth” command, the controller 24 may (1) open the electrically operable valve 22 for a short, preset duration for the user to wet his toothbrush, (2) close the electrically operable valve 22 for a short, preset duration for the user to apply toothpaste to the toothbrush, and (3) again open the electrically operable valve 22 for the user to rinse his mouth. The controller 24 can again close the valve 22 after a short, preset duration, or only after an additional command input from the user. In this operation, the water dispensed may be set at a predetermined cold temperature (e.g., as detected by temperature sensor 54). While the brush teeth mode is similar to the wash hands mode, the programmed times of operation and water temperatures are illustratively different.

In another illustrative example, a “fill object” command may cause the controller 24 to open the electrically operable valve 22 for a preset duration, or for a preset volume as measured by the flow sensor 256, for dispensing a set amount of water sufficient to fill a container, and then close the electrically operable valve 22. Different commands may be used to dispense different set amounts of water for filling different containers. Illustrative commands may include, for example, “fill cup”, “fill pitcher”, “fill gallon”, etc.

A “warm up” command may cause the controller 24 to open the electrically operably valve 22 until the temperature of water dispensed (e.g., as detected by temperature sensor 54) meets or exceeds a predetermined value.

The various commands may be initiated through a variety of different inputs on the faucet 10 including, for example, voice input, capacitive sensors, infrared sensors, etc. For capacitive sensors 26, for example, the user may perform a touch sequence (e.g., double tap) or combination touch (e.g., hold the spout 12 and turn the handle 14 to warm, hold the spout 12, and double tap the handle 14). Once a command is issued, the execution of the command may occur using microprocessor 42 to keep track of elapsed time and reading of sensors (e.g., flow, temperature, etc.) to control water flow.

When the electronic faucet 10 is being controlled by voice recognition, then it is advantageous to reduce background noise supplied to the voice recognition and conversion device 252. As such, a laminar flow stream straightener may be provided in the flow path between the valve 22 and the outlet of the spout 12. In one illustrative embodiment, the laminar flow stream straightener may be an aerator coupled to the outlet 19 of the spout 12. More particularly, the aerated water may be forced through the holes or apertures in a dispersal disc and then forced through at least one screen which creates a laminar stream of aerated water as it exits from aerator. It may be appreciated that other types of stream straighteners may be used at a variety of locations in the flow path.

Data may be transmitted bi-directionally between the wireless control module 200 and the voice recognition and conversion device 252. More particularly, the device 200 and/or the voice recognition and conversion device 252 illustratively includes a speaker to convey information verbally to the user. For example, the device 200 and/or the voice recognition and conversion device 252 may provide information on the battery life of the unit, water temperature, warm-up feature, flow usage, water quality, water pressure, volume of water dispensed, desired temperatures set, custom object naming for volume that could be dispensed (e.g., cup, pitcher, etc.), custom object naming for other functions (temperature, quality, etc.), and set timer so that it would turn on/off at specified times.

It should be appreciated that variations to the command inputs and corresponding response outputs shown in FIG. 11 may be provided. Additionally, in other illustrative embodiments, variations of the state diagram of FIG. 11 may be utilized in connection with commands related to the above-details Sabbath mode, Aging in Place, night light and freeze protection embodiments, for example.

While the above description illustrates the valve assembly and the wireless control module for use in connection with electronic faucet 10, such as a kitchen faucet, it should be appreciated that they may be used in connection with other devices, such as a shower valve, a bathtub, a toilet, an outdoor spigot, etc.

Although the invention has been described in detail with reference to certain preferred embodiments, variations and modifications exist within the spirit and scope of the invention as described and defined in the following claims.

1. An electronic faucet comprising:
a spout;
a fluid passageway supported by the spout;
a valve assembly including an electrically operable valve positioned to control fluid flow through the fluid passageway;
a valve controller operative to control the electrically operable valve;
a scheduler in communication with the valve controller, the scheduler configured to receive user input to schedule set features of the electronic faucet, thereby defining different modes of operation; and
a wireless control module in communication with the valve controller and the scheduler, the wireless control module including a receiver configured to receive wireless signals from a remote transmitter and communicate with the valve controller and the scheduler to control operation of the electrically operable valve based on scheduled set features.

2. The electronic faucet of claim 1, wherein the electrically operably valve comprises a solenoid valve including a solenoid coil and a moveable valve member operably coupled to the moveable valve member.

3. The electronic faucet of claim 2, wherein the valve controller includes a circuit board coupled to the valve assembly and a processor mounted to the circuit board to control the solenoid valve.

4. The electronic faucet of claim 1, wherein the receiver comprises a wireless chip configured to communicate with a wireless network.

5. The electronic faucet of claim 1, wherein the remote transmitter comprises at least one of a smart phone, a tablet or a dedicated remote user interface in wireless communication with the receiver.

6. The electronic faucet of claim 1, wherein the wireless control module includes a body defining a waterway in fluid communication with the valve assembly.

7. The electronic faucet of claim 6, wherein the wireless control module further includes a flow sensor received within the waterway.

8. The electronic faucet of claim 7, wherein the valve controller controls the electronically operable valve to dispense a predetermined amount of water based on input from the flow sensor.

9. The electronic faucet of claim 7, wherein the valve controller monitors water usage based on input from the flow sensor.

10. The electronic faucet of claim 7, wherein the flow sensor comprises a magnetic flow turbine.

11. The electronic faucet of claim 6, wherein the wireless control module further includes a temperature sensor received within the flow passage and in communication with the wireless controller.

12. The electronic faucet of claim 6, wherein the body of the wireless control module is releasably coupled between an outlet of the valve assembly and the spout.

13. The electronic faucet of claim 1, wherein a cable electrically connects the wireless control module with the controller.

14. The electronic faucet of claim 1, wherein the receiver is a transceiver supported on a printed circuit board.

15. The electronic faucet of claim 1, wherein the set features include a holiday mode.

16. The electronic faucet of claim 15, wherein the holiday mode is configured to restrict use of the electronic faucet during a religious holiday.

17. The electronic faucet of claim 16, wherein the holiday mode is a Sabbath mode includes the settings of full feature during non-Sabbath, and restricted feature during Sabbath.

18. The electronic faucet of claim 16, wherein the scheduler communicates with the valve controller to determine the setting to be inactive during the holiday mode.

19. The electronic faucet of claim 1, wherein the electronic faucet includes a light at a base of the electronic faucet.

20. The electronic faucet of claim 18, wherein the set features include a night light control mode for the light based on time-of-day.

21. The electronic faucet of claim 1, wherein the set feature includes an aging-in-place mode.

22. The electronic faucet of claim 20, wherein the scheduler is configured to monitor time lapses between uses of the faucet.

23. The electronic faucet of claim 21, wherein the valve controller is configured to detect and report a problem after a predetermined amount of time has lapsed since the last use of the faucet.

24. The electronic faucet of claim 22, wherein the valve controller reports a location of the user to a predetermined entity.

25. The electronic faucet of claim 1, wherein the set features include a freeze protection mode.

26. The electronic faucet of 25, wherein the scheduler is configured to communicate with the wireless control module to monitor a local weather forecast.

27. The electronic faucet of claim 25, wherein the scheduler is configured to communicate with the valve controller to activate the valve assembly to supply a sufficient flow of water to prevent the spout from freezing.

28. The electronic faucet of claim 1, wherein geographic location information is communicated with the wireless control module wherein the valve controller operates the electrically operable valve in response to the geographic location information.

29. A water control system comprising:
a fluid passageway defining a water outlet;
a valve assembly including an electrically operable valve to control fluid flow through the fluid passageway to the water outlet;
a valve controller operably coupled to the electrically operable valve, the valve controller including a processor and a memory operably coupled to the processor, the memory configured to store date information and time information;
a scheduler in communication with the valve controller;
wherein the processor is configured to cause selective operation of the electrically operable valve between a default mode and a holiday mode in response to input from the scheduler;
wherein in the default mode, the valve controller permits operation of the electrically operable valve to provide water to the water outlet; and
wherein in the holiday mode, the valve controller prevents operation of the electrically operable valve.

30. The water control system of claim 29, wherein the holiday mode is configured to restrict use of the electrically operable valve during a religious holiday by the processor comparing date information and time information stored in memory to a calendar of the scheduler.

31. The water control system of claim 30, wherein the holiday mode is a Sabbath mode including the settings of full feature during non-Sabbath, and restricted feature during Sabbath.

32. (canceled)

33. The water control system of claim 29, further comprising a wireless control module in communication with the valve controller and the scheduler, the wireless control module including a receiver configured to receive wireless signals from a remote transmitter and communicate with the valve controller and the scheduler to control operation of the electrically operable valve based on scheduled set features.

34.-36. (canceled)

37. An electronic faucet comprising:
a spout;
a fluid passageway supported by the spout;
a valve assembly including an electrically operable valve positioned to control fluid flow through the fluid passageway;
a valve controller operative to control the electrically operable valve, the valve controller including a processor and a memory operably coupled to the processor, the memory configured to store date information and time information;
a flow sensor fluidly coupled to the fluid passageway and in communication with the processor; and
a wireless control module in communication with the valve controller, the wireless control module including a transceiver configured to communicate with a remote device; and
wherein the processor in an aging-in-place mode of operation causes the transceiver to selectively send an alert to the remote device in response to input from the flow senor to the processor.

38. The electronic faucet of claim 37, wherein the processor is configured to monitor time lapses between uses of the faucet as detected by the flow sensor.

39. The electronic faucet of claim 38, wherein the valve controller is configured to detect and report a problem after a predetermined amount of time has lapsed since the last use of the faucet.

40.-41. (canceled)

42. The electronic faucet of claim 37, further comprising a scheduler in communication with the valve controller, the scheduler configured to receive user input to schedule set features of the electronic faucet, the set features including the aging-in-place mode.

43.-51. (canceled)
